(19) United States
(12) Patent Application Publication
(10) Pub. No.: US 2011/0156444 A1
(43) Pub. Date: Jun. 30, 2011

(54) PANEL STRUCTURE AND MANUFACTURING METHOD THEREOF

(75) Inventors: Sen Tao, Tochigi (JP); Keishi Okunaka, Tochigi (JP); Hirotatsu Koda, Tochigi (JP); Kenji Shiobara, Tochigi (JP)

(73) Assignee: HONDA MOTOR CO., LTD., Tokyo (JP)

(21) Appl. No.: 12/971,636

(22) Filed: Dec. 17, 2010

(30) Foreign Application Priority Data
Dec. 25, 2009 (JP) 2009-294692

(51) Int. Cl. B62D 29/00; B23P 11/00

(52) U.S. Cl. 296/191; 29/505

(57) ABSTRACT

A panel structure is manufactured by: overlapping a second plate member 12 on a first plate member 14 including a panel body 36 and a flange portion 38 continuing from the panel body 36; and bending the flange portion 38 so that the flange portion 38 curves from a boundary portion between the flange portion 38 and the panel body 36 to an end portion 30b of the flange portion 38 to thereby sandwich the second plate member 12 by the first plate member 14.

### BACKGROUND OF THE INVENTION

1. Field of the Invention

The present invention relates to a panel structure including a first plate member having a panel body and a flange portion continuing to the panel body and a second plate member superimposed on the first plate member, and a manufacturing method of the panel structure.

2. Related Art

Conventionally, at an end portion of a panel structure used in a hood, a trunk, doors etc. of an automobile, there has been employed a structure where an outer panel and an inner panel are overlapped with each other and a flange formed at an edge portion of the outer panel is folded to sandwich the inner panel.

For example, JP-B2-3669259 discloses a technique in which, as shown in FIG. 12A to 12C, an inner panel 204 is overlapped on an outer panel 202 having an outer peripheral flange 200 pre-folded in an L-shape (see FIG. 12A), then a flat portion of the outer peripheral flange 200 is pressed toward the inner panel 204 to thereby further bend the pre-folded or bent portion 206 of the outer peripheral flange 200 (see FIG. 12B), and a part of the flat portion opposing the inner panel 204 is pushed from the upper direction to thereby abut the flat surface of the flat portion against the inner panel 204 (see FIG. 12C), whereby the bent portion 206 of the outer peripheral flange 200 is formed in a bead-like shape in its section.

According to the structure of JP-B2-3669259, since the flat surface of the flat portion of the outer peripheral flange is abutted against the inner panel, it is difficult to secure a sufficient amount of the sectional area as to the bent portion (edge portion of a panel structure) of the outer peripheral flange. Thus, there may arise a case that the rigidity of the edge portion of the panel structure is insufficient.

Further, since the pre-folded portion of the outer peripheral flange is processed so as to be further bent, the outer surface of the edge portion of the panel structure is extremely extended, whereby the extended portion maybe broken.

### SUMMARY OF THE INVENTION

One or more embodiments of the invention provide a panel structure which can enhance a rigidity of an edge portion, and a manufacturing method thereof.

In accordance with one or more embodiments of the invention, a panel structure 16 is provided with: a first plate member 14 including a panel body 36 and a flange portion 38 continuing from the panel body 36; and a second plate member 12 which overlaps with the first plate member. The flange portion 38 curves from a boundary portion between the flange portion 38 and the panel body 36 to an end portion 30b of the flange portion 38 and is configured to cover an end portion 28 of the second plate member 12.

In accordance with one or more embodiments of the invention, a panel structure is manufactured by overlapping a second plate member 12 on a first plate member 14 including a panel body 36 and a flange portion 38 continuing from the panel body 36; and bending the flange portion 38 so that the flange portion 38 curves from a boundary portion between the flange portion 38 and the panel body 36 to an end portion 30b of the flange portion 38 to thereby sandwich the second plate member 12 by the first plate member 14.

### BRIEF DESCRIPTION OF THE DRAWINGS

FIG. 1 is a partially broken-out sectional and perspective view of the rear door of an automobile to which a panel structure according to an exemplary embodiment is applied.

FIG. 2 is a front view of the rear door of the automobile seen from a direction A in FIG. 1.

FIG. 3 is a flow chart showing a manufacturing process of the rear door of the automobile according to the exemplary embodiment.

FIG. 4 is a diagram for explaining a state where an inner panel and an outer panel are overlapped on a mounting surface before forming an edge portion of the panel structure according to the exemplary embodiment.

FIGS. 5A to 5D are sectional diagrams showing a first portion of the inner panel and the outer panel. FIG. 5A is a sectional diagram showing a state where a curl punch is made in contact with an end portion of the outer panel. FIG. 5B is a sectional diagram showing a state where the first portion of the outer panel is bent. FIG. 5C is a sectional diagram showing a state where a curl forming process is completed. FIG. 5D is a sectional diagram showing a state where a seam forming process is completed.

FIGS. 6A to 6D are sectional diagrams showing a second portion of the inner panel and the outer panel. FIG. 6A is a sectional diagram showing a state where the curl punch is slid toward the outer panel side. FIG. 6B is a sectional diagram showing a state where the curl punch is made in contact with the end portion of the outer panel. FIG. 6C is a sectional diagram showing a state where the curl forming process is completed. FIG. 6D is a sectional diagram showing a state where the seam forming process is completed.

FIG. 7 is an enlarged sectional diagram showing the second edge portion of the panel structure subjected to the curl forming.

FIG. 8 is an enlarged sectional diagram showing the second edge portion of the panel structure subjected to the seam forming.

FIG. 9 is a graph showing an extension amount of the bent portion of the outer panel in a bending process at the time of bending the outer panel toward the inner panel side in the overlapping state of the inner panel and the outer panel.

FIG. 10 is a perspective view of the body of the automobile, seen from the front direction thereof, representing portions where the panel structure according to the invention is applied to the automobile.

FIG. 11 is a perspective view of the body of the automobile, seen from the rear direction thereof, representing the portions where the panel structure according to the invention is applied to the automobile.

FIGS. 12A to 12C are diagrams for explaining a hemming processing method of a conventional art. FIG. 12A is a sectional diagram showing a state where the edge portion of an outer panel is bent in an L-shape to form an outer peripheral flange. FIG. 12B is a sectional diagram showing a state where the outer peripheral flange is further bent. FIG. 12C is a sectional diagram showing a state where the outer peripheral flange is pressed from the upper direction to thereby abut against an inner panel.

### DETAILED DESCRIPTION OF THE EXEMPLARY EMBODIMENTS

Hereinafter, a panel structure and a manufacturing method thereof according to the invention will be explained as to an exemplary embodiment, with reference to accompanying drawings.

The exemplary embodiment will be explained as to a case where the panel structure according to the invention is applied to a rear door of an automobile.

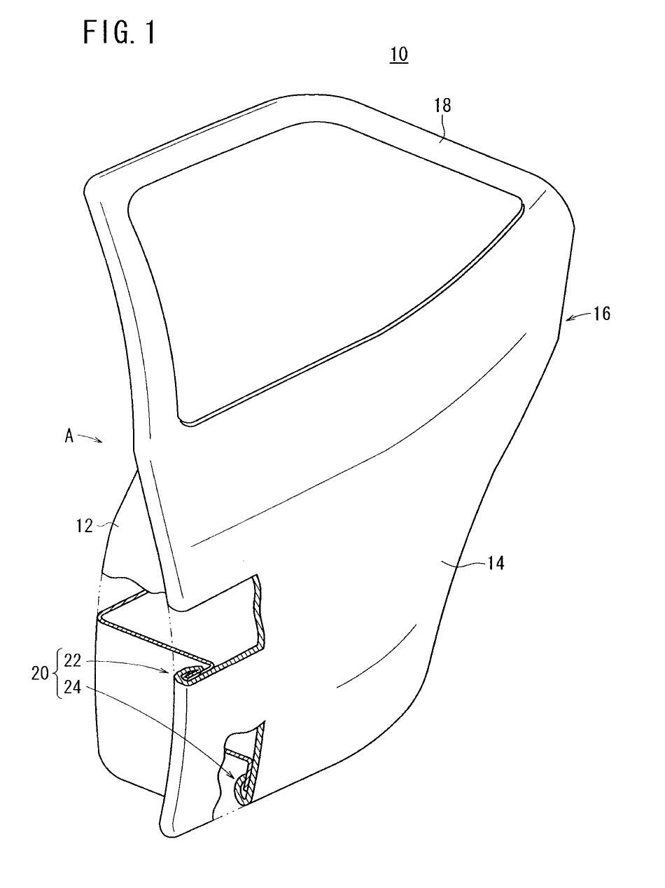

First, an explanation will be made as to a structure of the rear door of the automobile. As shown in FIG. 1, the rear door 10 of the automobile includes a panel structure 16 which is formed by engaging (fastening) an edge portion of an inner panel 12 as a second plate member and an edge portion of an outer panel 14 acting as a first plate member. A window frame 18 is formed at the panel structure 16. Each of the inner panel 12 and the outer panel 14 is formed by steel metal which is subjected to a punching process so as to have a predetermined shape.

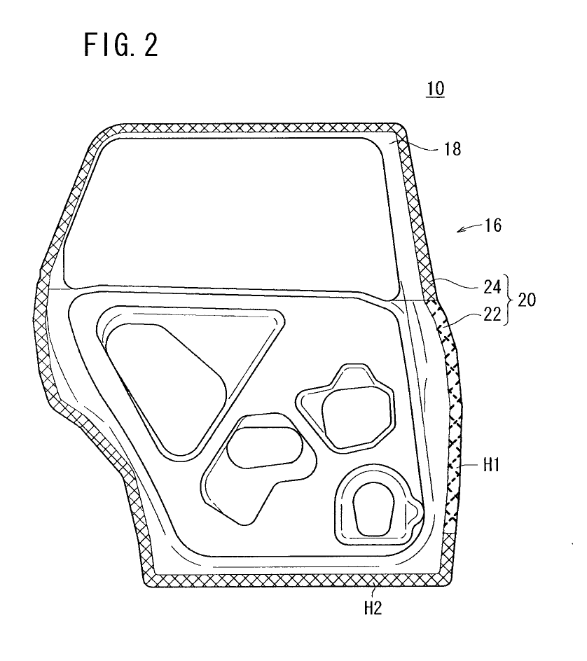

As shown in FIGS. 1 and 2, an edge portion 20 of the panel structure 16 extends over an entire periphery of an automobile rear door 10 in a three-dimensional manner. This edge portion includes a first edge portion (a band-shaped mesh portion H1 shown by dotted lines in FIG. 2) 22 to be attached to a not-shown main body of the automobile and a second edge portion (a band-shaped mesh portion H2 shown by steady lines in FIG. 2) 24 having a structure different from that of the first edge portion 22.

As shown in FIG. 1, the first edge portion 22 is wound up so as to contain therein both the end surface of the outer panel 14 and the end surface of the inner panel 12. The second edge portion 24 is configured in a manner that the edge portion of the outer panel 14 is curved (subjected to the hemming processing) toward the panel 12 side so that the outer panel 14 covers the end portion of the inner panel 12. Thus, the fastening intensity of the first edge portion 22, to which a load is applied in a state where the automobile rear door 10 is attached to the main body of the automobile, can be enhanced and the structure of the second edge portion 24, to which a large load is not applied, can be simplified.

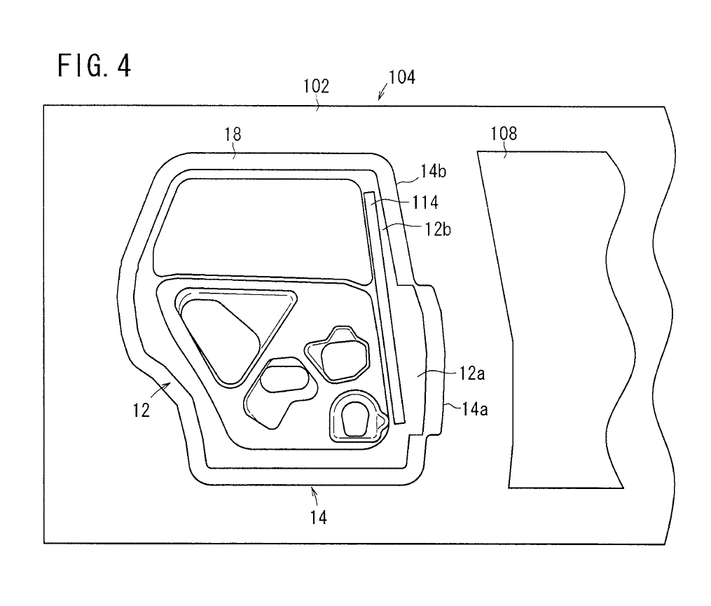

Next, a processing apparatus 100 for manufacturing the automobile rear door 10 will be explained with reference to FIGS. 4 to 6D.

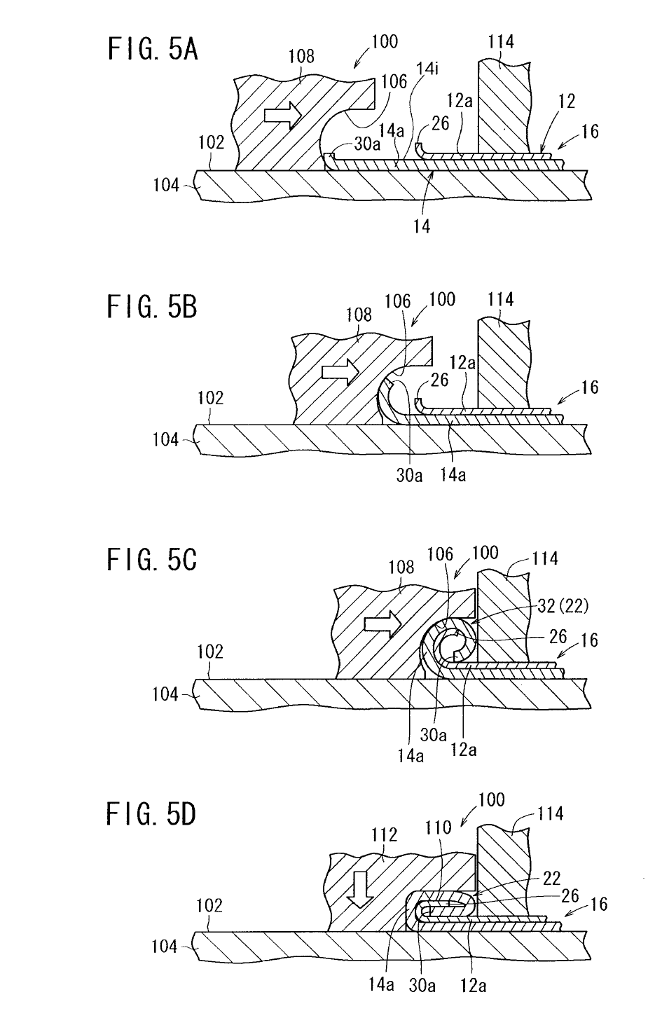

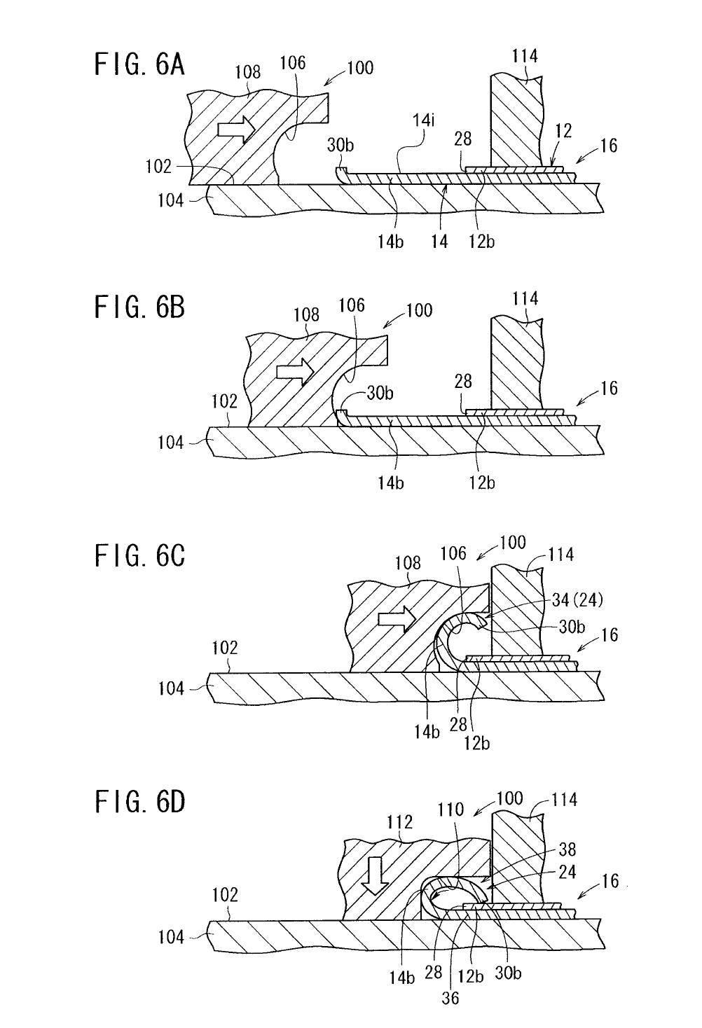

As shown in FIGS. 4 to 6D, the processing apparatus 100 (see FIGS. 5A and 6A) includes a mounting table 104 which is installed on the floor of a factory etc. and has a mounting surface 102 on which the outer panel 14 is mounted, a curl punch 108 (see FIGS. 5A and 6A, for example) which is mounted on the mounting surface 102 so as to be slidable (freely slidable) and acts as a forming member having a curved surface 106 with a curvature radius of an almost complete round, a seam punch 112 (see FIGS. 5D and 6D) having a forming surface 110 formed in an almost L-shape in its section, and a pressing pad 114 acting as a holding means for holding the inner panel 12 and the outer panel 14 on the mounting surface 102.

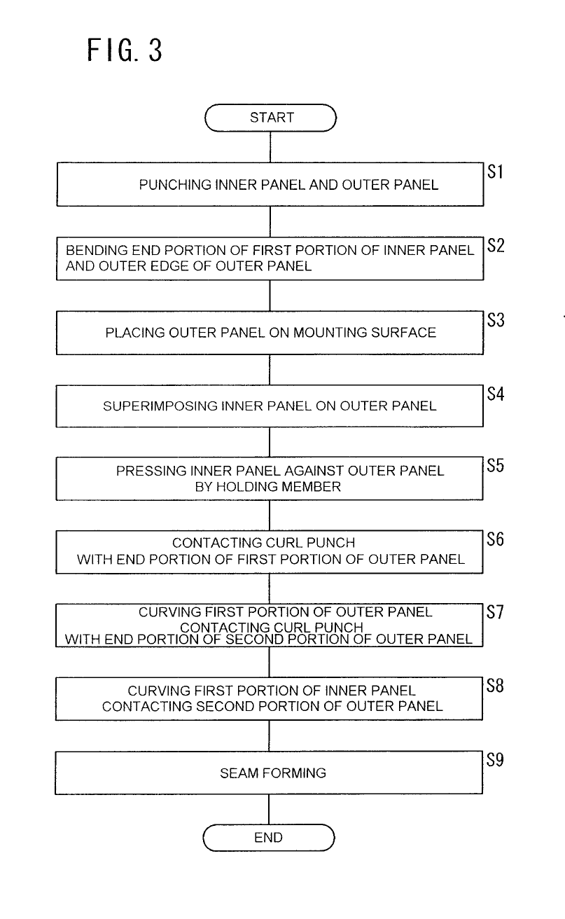

The manufacturing method of the automobile rear door 10 according to the exemplary embodiment will be explained with reference to FIGS. 3 to 60. FIGS. 5A to 6D show the manufacturing process of the edge portion 20 of the panel structure 16. FIGS. 5A to 5D are sectional diagrams showing the first portion 12a of the inner panel 12 and the first portion 14a of the outer panel 14, and FIGS. 6A to 6D are sectional diagrams showing the second portion 12b of the inner panel 12 and the second portion 14b of the outer panel 14. FIGS. 5A to 5D respectively correspond to FIGS. 6A to 6D.

Firstly, as shown in FIG. 4, each of the inner panel 12 and the outer panel 14 is subjected to the punching processing so as to have a predetermined shape (step S1 of FIG. 3), whereby the window frame 18 etc. are formed at the inner panel 12 and the outer panel 14. In the inner panel 12 and the outer panel 14, the portions (first portions) 12a, 14a corresponding to the first edge portion 22 of the automobile rear door 10 are extended outwardly with respect to the portions (second portions) 12b, 14b corresponding to the second edge portion 24.

Further, as shown in FIG. 5A, the end portion 26 of the first portion 12a of the inner panel 12 is slightly bent on the inner side and also the outer edge of the outer panel 14 is slightly bent on the inner side (step S2). In this case, the inner surfaces of the inner panel 12 and the outer panel represent surfaces located on the interior side of the automobile at the time of attaching the automobile rear door 10 to the automobile main body. On the contrary, the outer surfaces of the inner panel 12 and the outer panel 14 represent surfaces located on the outside of the automobile at the time of attaching the automobile rear door 10 to the automobile main body. As shown in FIG. 6A, the end portion 28 of the second portion 12b of the inner panel 12 is not bent and maintains a flat state.

Next, as shown in FIGS. 4, 5A and 6A, the outer panel 14 is placed on the mounting surface 102 in a state of directing the outer surface of the outer panel 14 downwardly (a state of directing the end surface of the outer panel 14 upwardly) (step S3), whereby a small gap is formed between the end portion 30a of the outer panel 14 and the mounting surface 102 (see FIGS. 5A and 6A).

Then, as shown in FIGS. 5A and 6A, the inner panel 12 is overlapped on an inner surface 14i of the outer panel 14 in a state of directing the outer surface of the inner panel 12 downwardly (a state of directing the end surface of the first portion 12a of the inner panel 12 upwardly) (step S4). In this case, the outer panel 14 protrudes from the end portion of the inner panel 12. Thus, a small gap is formed between the end portion 26 of the first portion 12a of the inner panel 12 and the outer panel 14 (see FIG. 5A).

Thereafter, the inner panel 12 is pressed against the outer panel 14 by using the pressing pad 114 (step S5), whereby the inner panel 12 and the outer panel 14 are held on the mounting surface 102.

Then, as shown in FIG. 5A, the curl punch 108 is slid on the outer panel 14 (pressing pad 114) side to thereby contact the curved surface 106 of the curl punch 108 with the end portion 30a of the first portion 14a of the outer panel 14 (step S6). In this case, as clear from FIG. 5A, a part of the curl punch 108 enters into the gap between the end portion 30a of the first portion 14a of the outer panel 14 and the mounting surface 102. As shown in FIG. 6A, in this case, of course, the curl punch 108 does not contact with the second portion 14b of the outer panel 14.

Next, as shown in FIGS. 5B and 6B, the curl punch 108 is slid toward the pressing pad 114 side thereby to bend the first portion 14a of the outer panel 14 in a curved shape (curling processing) and also to contact the curl punch 108 with the end portion 30b of the second portion 14b of the outer panel (step S7). The explanation will be made concretely as to the operation for curving the first portion 14a of the outer panel 14. When the curl punch 108 is further slid toward the pressing pad 114 side, apart contacting with the curved surface 106 of the first portion 14a of the outer panel 14 is pressed on the inner panel 12 (pressing pad 114) side and raised along the curved surface 106 while causing plastic deformation. As a result, the first portion 14a of the outer panel 14 is curved upwardly. Since the contacting operation between the second portion 14b of the outer panel 14 and the curved surface 106 is similar to the contacting operation between the first portion 14a of the outer panel 14 and the curved surface 106 explained in the step S6, the detailed explanation thereof will be omitted (see FIG. 6B).

Thereafter, as shown in FIGS. 5C and 6C, the curl punch 108 is furthermore slid toward the pressing pad 114 side to thereby curve the first portion 12a of the inner panel 12 and also curve the second portion 14b (flange portion, protruded portion) of the outer panel 14 of the outer panel 14 (step S8). Since the operation for curving the second portion 14b of the outer panel 14 is similar to the operation for curving the first portion 14a of the outer panel 14 explained in the step S7, the detailed explanation thereof will be omitted. Further, in this case, the second portion 14b of the outer panel 14 is formed so as to have a shape almost same as the shape of the curved surface 106. In this manner, an edge portion corresponding to the first edge portion 22 of the panel structure 16 (see FIGS. 1 and 2) and an edge portion corresponding to the second edge portion 24 of the panel structure (see FIGS. 1 and 2) are provisionally formed (curl forming). In the following explanation, the edge portion corresponding to the first edge portion 22 of the panel structure 16 formed by the curl processing will be explained as a first corresponding edge portion 32, and the edge portion corresponding to the second edge portion 24 of the panel structure 16 formed by the curl processing will be explained as a second corresponding edge portion 34.

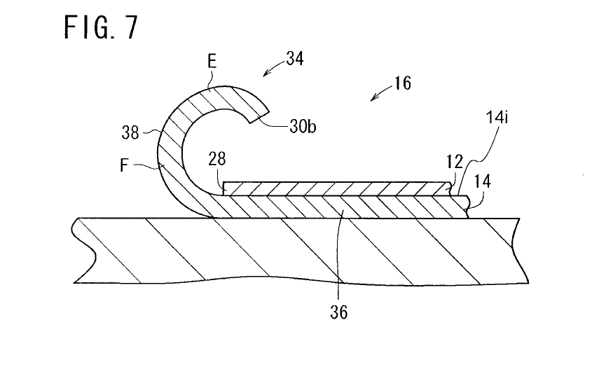

Before the explanation of the next step, the second corresponding edge portion 34 of the panel structure 16 formed in the step S8 will be explained in detail with reference to FIG. 7. As shown in FIG. 7, the second corresponding edge portion 34 of the panel structure 16 includes a flat portion 36 as a panel body on which the inner panel 12 is overlapped and a flange portion 38 continuing to the flat portion 36. The flange portion 38 is curved from the boundary portion between the flange portion and the flat portion 36 to the end portion 30b of the flange portion 38. In other words, the flange portion 38 is configured in an almost C-shape in its section and covers the end portion 28 of the second portion 12b of the inner panel 12. The end portion 28 contacts with the flat portion 36. As shown in FIG. 5C, the first corresponding edge portion 32 of the panel structure 16 contains therein the end portion 30a of the first portion 14a of the outer panel 14 and the end portion 26 of the first portion 12a of the inner panel 12.

Succeedingly, as shown in FIGS. 5D and 6D, each of the first corresponding edge portion 32 and the second corresponding edge portion 34 of the panel structure 16 formed by the curl processing is subjected to the seam forming (step S9). To be concrete, after removing the curl punch 108 located on the mounting surface 102, each of the first corresponding edge portion 32 and the second corresponding edge portion 34 of the panel structure 16 is pressed against the mounting surface 102 (toward the thickness direction of the flat portion 36) by the seam punch 112. Thus, the first corresponding edge portion 32 and the second corresponding edge portion 34 of the panel structure 16 are deformed in flat shapes to thereby form the first edge portion 22 and the second edge portion 24, respectively. After the completion of the step S9, the manufacturing process of the automobile rear door 10 is terminated.

Next, the explanation will be made as to the edge portion 24 of the panel structure 16 formed in the step S9.

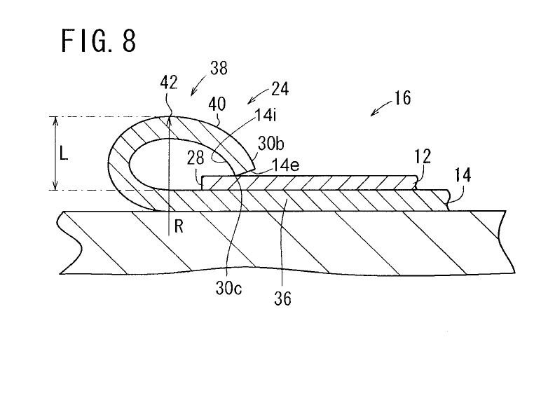

As shown in FIG. 8, the flange portion 38 of the second edge portion 24 of the panel structure 16 is arranged in a manner that the curvature radius R of the outer periphery of a folding portion 40 opposing to the flat portion 36 is larger than a distance L from the apex portion 42 of the folding portion 40 so the flat portion 36. Further, the corner portion (end portion) 30c of the flange portion 38 continuing to the inner surface 14i of the outer panel 14 which is in contact with the inner panel 12 abuts against the inner panel 12. That is, as shown in FIG. 8, the end portion 30b of the flange portion 38 is configured at least by the inner surface 14i of the outer panel 14 and an edge surface 14e intersecting to the inner surface 14i, and the corner portion 30c formed by the inner surface 14i and the edge surface 14e is in contact with the inner panel 12. The end portion 28 of the second portion 12b of the inner panel 12 contacts with the flat portion 36.

Thus, the scrape or damage of the inner panel 12 can be suppressed as compared with a case where the end surface of the flange portion 38 abuts against the inner panel 12 while suppressing the entering of foreign material into the inner space of the second edge portion 24 of the panel structure 16 from the outside. In this case, since the flange portion 38 is unlikely restored to a non-wound state, the end portion 30b of the flange portion 38 hardly separates from the inner panel 12 even in the case of the springback. As understood from FIG. 8, the flange portion 38 is placed in a curved state from the boundary portion between the flange portion and the flat portion 36 to the end portion 30b of the flange portion 38 even after the seam forming. Further, throughout a whole range from the boundary portion to the end portion 30b, a direction of a curve is unchanged. That is, throughout the whole range from the boundary portion to the end portion 30b, the outer panel 14 curves toward a side of the inner surface 14i.

According to the automobile rear door 10 configured in the aforesaid manner, in the second edge portion 24 of the panel structure 16, since the flange portion is curved from the boundary portion between the flange portion 38 and the flat portion 36 to the end portion 30b of the flange portion 38, the sectional area of the second edge portion 24 of the panel structure 16 can be made larger as compared with a case where a part of the flange portion 38 is formed in a flat shape, for example. Thus, the rigidity of the second edge portion 24 of the panel structure 16 can be enhanced.

Further, in the second edge portion 24 of the panel structure 16, since the curvature radius R of the outer periphery of the folding portion 40 is larger than the distance from the apex portion 42 of the folding portion 40 to the flat portion 36, the second edge portion 24 can be suppressed from being expanded in an almost complete round shape in its section. Thus, it is possible to provide the second edge portion 24 of the panel structure 16 which is excellent in the quality of the outward appearance.

According to the manufacturing method of the automobile rear door 10 of this exemplary embodiment, in the curl forming process (steps S6 to S8) of the second edge portion 24 of the panel. structure 16, the second portion 14b is curved by pressing the portion of the second portion 14b of the outer panel 14 contacting with the curved surface 106 of the curl punch 108 toward the inner panel 12 side. Thus, the flat portion 36 of the outer panel 14 can be suppressed from being raised (lifted up) from the mounting surface 102. As a result, it is possible to prevent the occurrence of such a phenomenon that the flat portion 36 is lifted up from the mounting surface 102 to thereby curve the second portion 12b of the inner panel 12.

According to this exemplary embodiment, the first edge portion 22 and the second edge portion 24 having different structures can be formed simultaneously by extending the second portions 12b, 14b of the inner panel 12 and the outer panel 14 to the outer side than the first portions 12a, 14a thereof, respectively. As a result, the manufacturing time of the panel structure 16 can be shortened as compared with a case where the first edge portion 22 and the second edge portion 24 of the panel structure 16 are formed separately.

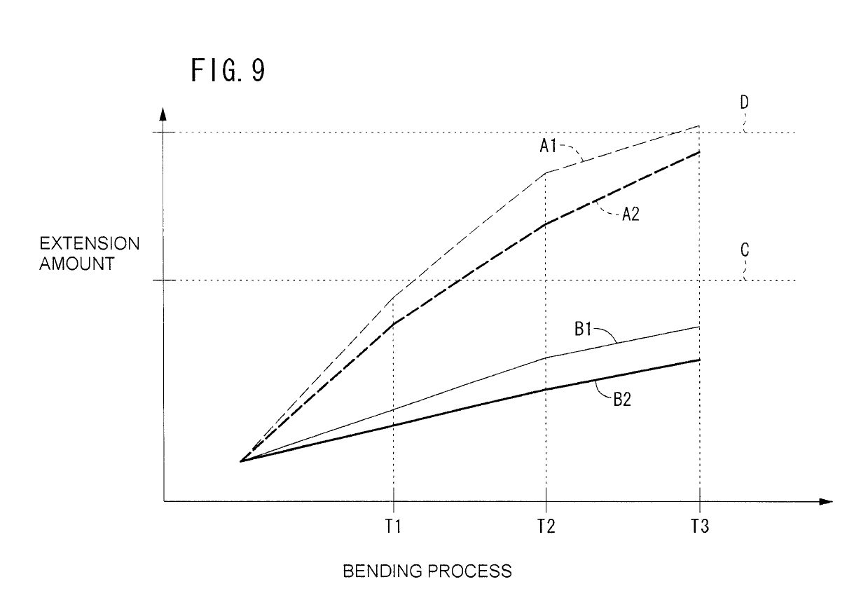

Next the function and effects of this exemplary embodiment will be explained in detail with reference to FIG. 9.

FIG. 9 is a graph showing an extension amount of the bent portion of the outer panel in the bending procedure (bending process) at the time of bending the outer panel toward the inner panel side in the overlapping state of the inner panel and the outer panel. In FIG. 9, dotted lines A1 and A2 are graphs representing cases where the bending processes (hemming processes, in general) of the related art are performed, in which the dotted line A1 shows a case where aluminum is used as the material of the outer panel and the dotted line A2 shows a case where iron is used as the material of the outer panel.

Further, in FIG. 9, steady lines B1 and B2 are graphs representing cases where the bending processes adapted to the second edge portion of the panel structure according to the exemplary embodiment are performed, in which the steady line B1 shows a case where aluminum is used as the material of the outer panel and the steady line B2 shows a case where iron is used as the material of the outer panel.

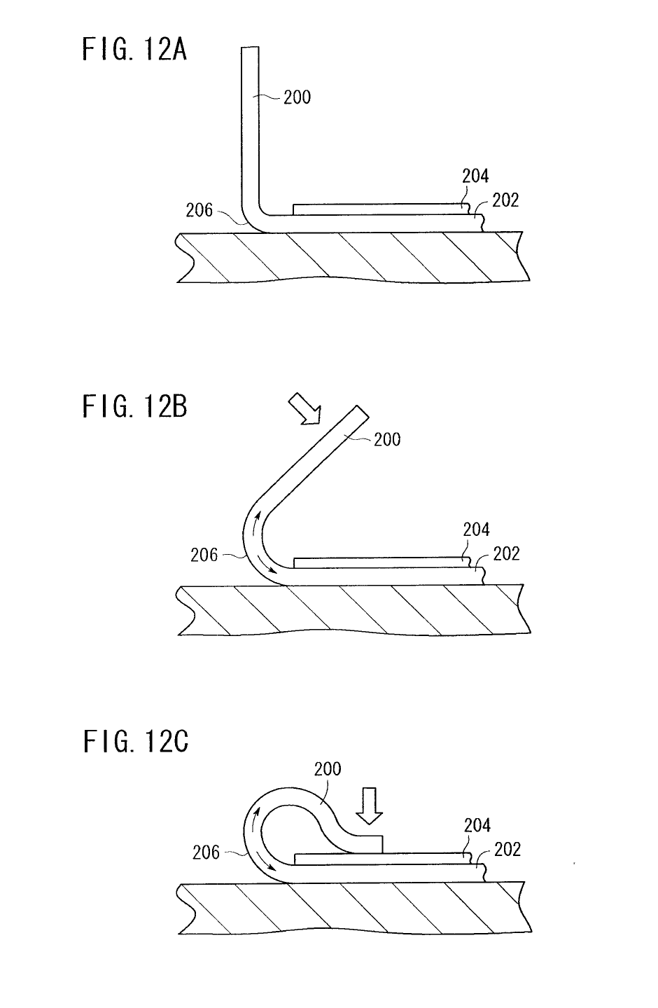

Furthermore, in the graphs of the dotted lines of FIG. 9, a process T1, a process T2 and a process T3 correspond to the states of FIGS. 12A, 12B and 12C, respectively. Also, in the graphs of the steady lines of this figure, the process T2 and the process T3 correspond to the states of FIGS. 7 and 8, respectively.

As shown in FIGS. 9 and 12A, in the case of performing the bending operation of the related art, it will be understood that the bent portion of the flange portion is abruptly extended when the edge portion of the outer panel is bent in an almost L-shape to form the flange portion.

Then, as shown in FIGS. 9 and 12B, when the flange portion thus bent in the almost L-shape is further bent, the bent portion of the flange portion is further extended to the direction shown by an arrow in FIG. 12B. As a result, the extension amount of the bent portion of the flange portion exceeds the limit extension amount of aluminum (a line C in FIG. 9). Thus, in the case where the outer panel is made of aluminum (dotted line A1 in FIG. 9), the bent portion of the flange portion may crack.

Further, as shown in FIGS. 9 and 12C, when the tip end of the flange portion is pressed from the upper direction so as to abut against the inner panel, the bent portion of the flange portion is further extended to the direction shown by an arrow in FIG. 12C. As a result, in the case where the outer panel is made of iron (dotted line A2 in FIG. 9), the extension amount of the bent portion of the flange portion reaches a value slightly smaller than the limit extension value of iron (line D in FIG. 9). Thus, even in the case where the outer panel is made of iron, the bent portion of the flange portion may crack depending on the thickness of the outer panel.

On the other hand, as shown in FIGS. 7 and 9, when the bending procedure according to the exemplary embodiment is performed, almost the entirety of the flange portion is extended by curving the flange portion from the boundary portion between the flange portion and the flat portion to the end portion of the flange portion in the curl forming process. Thus, the extension amount of the bent portion of the flange portion can be suppressed as compared with the aforesaid case of the related art.

Then, as shown in FIGS. 7, 8 and 9, in the case of pressing the flange portion from the upper direction to thereby abut against the inner panel in the seam forming process (step S9), the flange portion is deformed in a flat shape in a manner that the material located at a position shown by E in FIG. 7 flows toward a position shown by F. Thus, the extension amount of the bent portion of the flange portion is relatively smaller than the limit extension value of aluminum. Accordingly, it will be understood that the generation of crack at the second edge portion of the panel structure can be suppressed by applying the manufacturing method of the panel structure according to this exemplary embodiment.

The invention is not limited to the aforesaid specific exemplary embodiment and it is obvious that various configurations may be employed without departing from the gist at the invention

For example, although the panel structure is configured by using the two plate members of the inner and outer panels in the aforesaid exemplary embodiment, the invention is not limited thereto and the panel structure according to the invention can be worked even in a case where the panel structure is configured by three or more plate members.

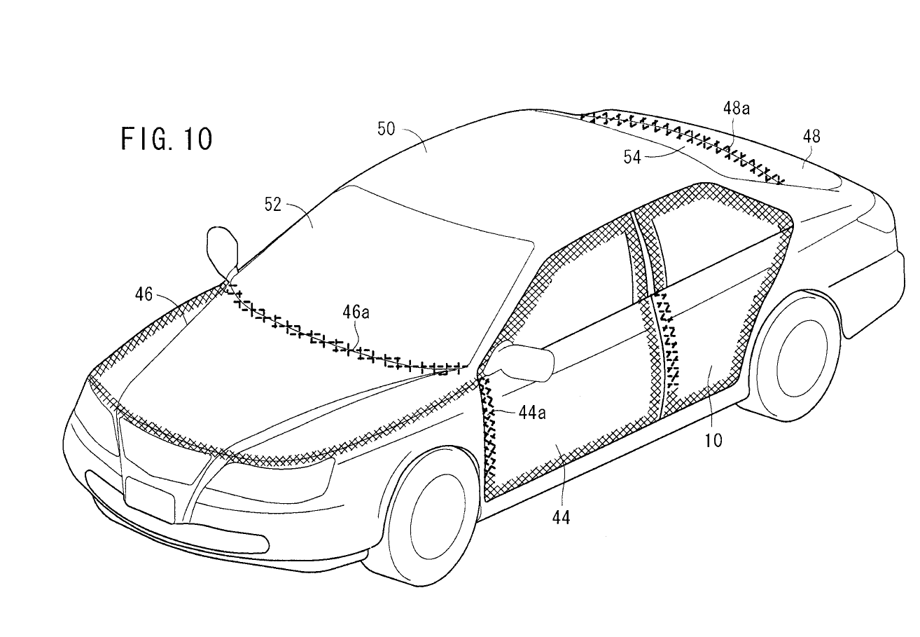

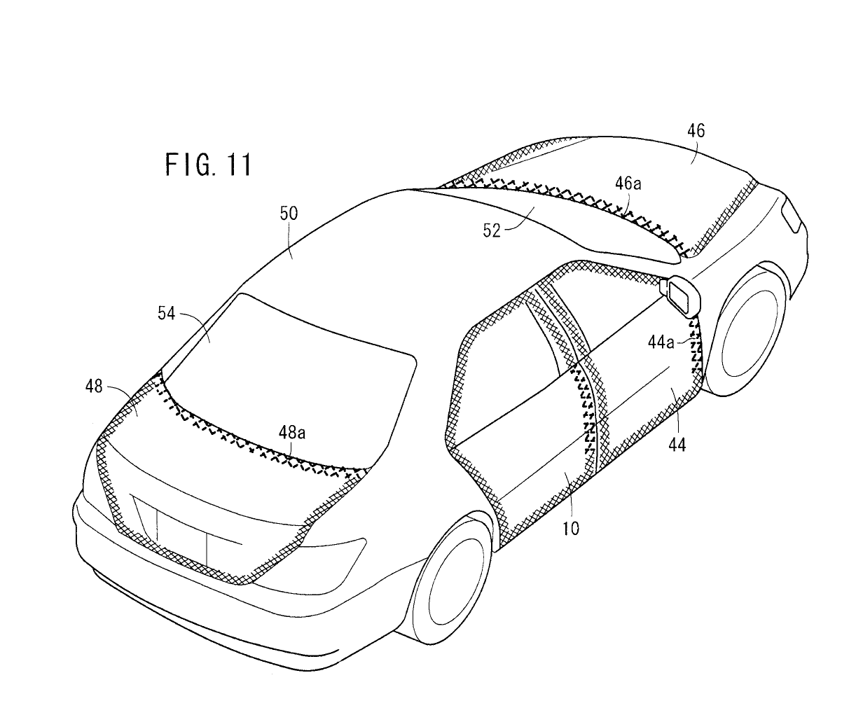

Further, although the exemplary embodiment is explained as to a case where the panel structure according to the invention is applied to the rear door of an automobile, as an example, the present invention is not limited thereto and the panel structure may of course be applied to other portions. For example, as shown in FIGS. 10 and 11, the panel structure may be applied to a front door 44, a bonnet 46, a trunk 48 etc. of an automobile. In this case, the edge portion of the panel structure may be formed by combining an edge portion H2 having the same configuration as the second edge portion of the panel structure according to the aforesaid exemplary embodiment and an edge portion H1 subjected to the winding-up process. For example, the winding-up process is preferably performed as to an edge portion 44a to be coupled to the main body 50 of an automobile of the front door 44 of the automobile, an edge portion 46a opposing to the front glass 52 of the bonnet 46 and an edge portion 48a opposing to the rear glass 54 of the trunk 48.

In the panel structure according to the invention, edge portions only subjected to the curl forming may be formed and employed, and so the seam forming is not necessarily required to be performed.

Further, the panel structure and the manufacturing method thereof according to the invention may of course be applied to products other than automobiles.

In accordance with the embodiment, a panel structure 16 is provided with: a first plate member 14 including a panel body 36 and a flange portion 38 continuing from the panel body 36; and a second plate member 12 which overlaps with the first plate member. The flange portion 38 curves from a boundary portion between the flange portion 38 and the panel body 36 to an end portion 30b of the flange portion 38 and is configured to cover an end portion 28 of the second plate member 12.

According to this configuration, since the flange portion is curved from the boundary portion between the flange portion and the panel body to the end portion of the flange portion, the sectional area of the edge portion of the panel structure can be made larger as compared with a case where a part of the flange portion is formed in a flat shape, for example. Thus, the rigidity of the edge portion of the panel structure can be enhanced.

In accordance with the embodiment, the panel structure is manufactured by the steps of overlapping a second plate member 12 on a first plate member 14 including a panel body 36 and a flange portion 38 continuing from the panel body 36; and bending the flange portion 38 so that the flange portion 38 curves from a boundary portion between the flange portion 38 and the panel body 36 to an end portion 30b of the flange portion 38 to thereby sandwich the second plate member 12 by the first plate member 14.

According to this method, since the flange portion is bent so as to curve from the boundary portion between the flange portion and the panel body to the end portion of the flange portion, the sectional area of the edge portion of the panel structure can be made larger as compared with a case where the panel structure is manufactured by, after pre-folding the flange portion of the first plate member in an almost L-shape, further bending the pre-folded portion of the first plate member, for example. Thus, the rigidity of the edge portion of the panel structure can be enhanced.

Further, the step of bending may include a curl forming step of subjecting the flange portion to a curl processing and a seam forming step of pressing the flange portion thus subjected to the curl forming toward the thickness direction of the panel body.

In this case, since the flange portion is curved by being subjected to the curl processing, the panel body can be prevented from being raised (lifted up) from a mounting surface on which the first plate member is mounted during the curl forming process. Thus, it is possible to prevent the occurrence of such a phenomenon that the panel body is lifted up from the mounting surface (that is, the panel body is deformed) to thereby curve the second plate member.

Further, in the seam forming step, the end portion of the flange portion may be abutted against the second plate member. In this case, the entering of foreign material from the outside into the edge portion of the panel structure can be suppressed. Since the flange portion is unlikely restored to a non-wound state, the end portion of the flange portion hardly separates from the second plate member even in the case of the springback.

Further, the end portion abutting against the second plate member may be the corner portion of the flange portion which continues to a surface contacting with the second plate member. Thus, the scrape or damage of the second plate member can be suppressed as compared with a case where the end surface of the flange portion abuts against the second plate member.

### DESCRIPTION OF REFERENCE NUMERALS AND SIGNS

10 rear door of automobile
12 inner panel
14 outer panel
16 panel structure
20 edge portion
30a, 30b end portion
32 first corresponding edge portion
34 second corresponding edge portion
36 flat portion (panel body)
38 flange portion
40 folding portion
42 apex portion

What is claimed is:

1. A panel structure comprising:
a first plate member including a panel body and a flange portion continuing from the panel body; and
a second plate member which overlaps with the first plate member,
wherein the flange portion curves from a boundary portion between the flange portion and the panel body to an end portion of the flange portion and is configured to cover an end portion of the second plate member.

2. The panel structure according to claim 1, wherein the flange portion abuts against the second plate member.

3. The panel structure according to claim 2, wherein the end portion abutting against the second plate member is a corner portion of the flange portion which continues to a surface contacting with the second plate member.

4. A method of manufacturing a panel structure, the method comprising:
overlapping a second plate member on a first plate member, the first plate member including a panel body and a flange portion continuing from the panel body; and
bending the flange portion so that the flange portion curves from a boundary portion between the flange portion and the panel body to an end portion of the flange portion to thereby sandwich the second plate member by the first plate member.

5. The method according to claim 4, wherein the flange portion is bent by a curl forming step of subjecting the flange portion to a curl processing and a seam forming step of pressing the curled flange portion in a thickness direction of the panel body.

6. The method according to claim 5, wherein, in the seam forming step, the end portion of the flange portion abuts against the second plate member.

7. The method according to claim 6, wherein the end portion abutting against the second plate member is a corner portion of the flange portion which continues to a surface contacting with the second plate member.
